(19) United States
(12) Patent Application Publication
(10) Pub. No.: US 2013/0235692 A1
(43) Pub. Date: Sep. 12, 2013

(54) Dust Mixing Device

(71) Applicant: Sebastian Hirschberg, Winterthur (CH)

(72) Inventor: Sebastian Hirschberg, Winterthur (CH)

(21) Appl. No.: 13/741,651

(22) Filed: Jan. 15, 2013

Related U.S. Application Data
(62) Division of application No. 13/134,230, filed on Jun. 2, 2011, now abandoned.

(30) Foreign Application Priority Data
Jun. 22, 2010 (EP) 10166948.9

(51) Int. Cl. B01F 5/06

(52) U.S. Cl. CPC B01F 5/0602
USPC 366/336

(57) ABSTRACT

A method of mixing dust comprises the step of introducing the dust into a closed passage and through a static mixer with a mixing element having a surface which is inclined with respect to the main axis of the closed passage and which is provided with a surface structure of a small scale, such that the dust particles arriving at the surface are reflected by the surface structure in a random manner.

This application is a Division of Ser. No. 13/134,230 filed Jun. 2, 2011.

The invention relates to a dust mixing method employing a static mixer for the mixing of dust and/or the homogeneous dispersion of dust in a passage. The static mixer is particularly suitable for a flue gas containing dust particles.

In practice, mixers with a cross channel structure according to DE 2 205 371 as combined mixer and vaporiser are in operation. The pressure drop of a mixer with a cross channel structure is however higher than the pressure drop of a mixing element, which makes use of guide vanes for deflecting the flow in the channel, such as the solution presented according to DE102008023585. Another type of mixing element employed for this purpose is shown in DE19539923 C1. However none of the prior art static mixers have been designed for mixing a dust within a gas, thus a flow containing solid particles.

It is an object of the invention to distribute dust homogeneously over the passage cross-section over a short path length by means of a static mixer.

The object of the invention is solved by a method of mixing dust comprising the step of introducing a flow of dust particles, typically contained in a flow of gas, into a closed passage, directing the flow in the closed passage to a static mixer, wherein the static mixer is disposed with a mixing element, the mixing element having a surface which is inclined with respect to the main axis of the closed passage with the surface of the mixing element being disposed with a surface structure of a small scale, such that the dust particles arriving at the surface are reflected by the surface structure in a random manner.

A dust mixing device according to the invention contains a closed passage disposed on a longitudinal axis; means for directing a flow of flue gas containing dust particles into the closed passage and along the longitudinal axis; and a static mixer arranged in the closed passage, wherein the static mixer comprises a mixing element for deflection of a flow of dust particles inside the passage and the mixing element is disposed at least partially with a surface structure of a small scale.

The flow of dust particles is deflected on the surfaces of the mixing element and a turbulent flow is obtained including the generation of vortices. For dust particles of a large size, typically for particles bigger then 0.05 mm, which are critical for erosion, these dust particles can not follow the deflection of the flow and therefore impact onto the surface of the mixing elements. The dust particles are reflected from the surface, continue their path in the flue gas flow until they arrive at a further mixing element surface or finally leave the static mixer. It has been observed that such large dust particles tend to concentrate at certain locations of the mixer. Due to the formation of such dust particle concentrations, the erosion effect can vary locally, thus there are locations with a pronounced erosion effect and other locations in the passage with a negligible erosion effect. When using a surface structure, this effect can be reduced as the dust particles are reflected from such a surface structure in a random manner.

The surface structure of a small scale advantageously comprises ribs, protrusions or grooves whereby the height or depth of the small scale structure is at least the average particle diameter d50 measured by mass of the dust. Thereby it is ensured that neighbouring dust particles arriving at the surface of the mixing element are reflected by different angles and thus contribute to the homogeneous distribution of the dust in the passage.

In particular, the surface structure comprises protrusions, ribs or grooves of a height or depth of at most 20 mm.

According to a particularly preferred embodiment the mixing element comprises a corrugated profile. Such a corrugated profile comprises a periodically repeating sequence of elevated portions and valley-like depressions. According to an advantageous embodiment, the corrugated profile can be shaped as a wave-shaped profile.

In particular, the static mixer comprises a first mixing element and a second mixing element, wherein the first mixing element comprises a first corrugated profile, said second mixing element comprises a second corrugated profile, wherein the second mixing element is arranged adjacent to the first mixing element, such that the corrugated profiles form a crosswise arrangement.

The corrugated profile can comprise a plurality of open channels whereby the open channels include a first corrugation valley, a first corrugation peak and a second corrugation peak, and the first corrugation peak and the second corrugation peak bound the first corrugation valley. The first corrugation peak and the second corrugation peak can have a first apex and a second apex and the corrugation valley can have a valley bottom.

Furthermore the first mixing element is advantageously in touching contact with the second mixing element, such that at least some of the apices of the corrugation peaks of the first mixing element and the valley bottoms of the corrugation valleys of the second mixing element have a common point of contact.

The angle between the open channels of neighbouring mixing elements is in a range of 10° to 90°, preferably in a range of 20° to 80° most preferred in a range of 25 to 75°.

The corrugated profile has a corrugation height, whereby the corrugation height is defined as the normal spacing between the first apex of the first corrugation peak and the valley bottom of the first corrugation valley. The surface structure of a small scale thus in particular the ribs, protrusions or grooves are preferably of a height or depth which is smaller than 1/20 of the corrugation height.

A preferred use of the dust mixing device in accordance with any of the preceding embodiments is for distributing dust homogeneously in the closed passage.

According to a second preferred embodiment, the static mixer includes at least one pair of guide elements. The guide elements are used for mixing of the dust and homogeneously distribute it across the passage. For a prolonged duration of the life time of equipment which is arranged in the flow path of the dust, it is important that the dust is distributed as homogeneously as possible over the largest possible cross-section of such equipment in order to avoid spots of erosion and/or corrosion.

According to a particularly advantageous embodiment the pair of guide elements includes a first vane and a second vane. Preferably the first and second vanes each comprise an edge at the leading side which is arranged perpendicular to the flow and parallel to the height or width of the passage. In the following the invention will be explained in connection with the figures. It is shown in:

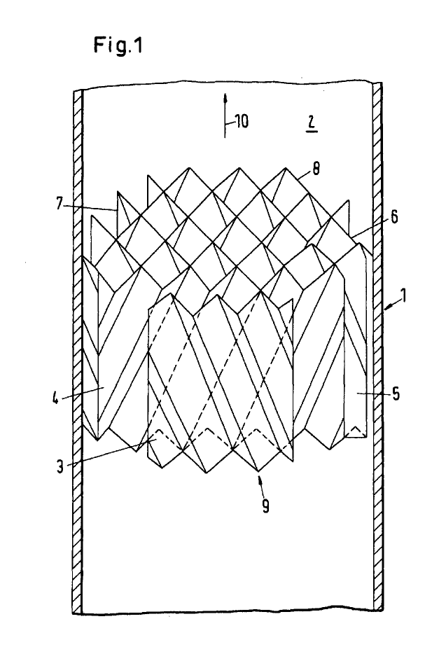

FIG. 1 a static mixer arranged in a passage;

FIG. 2 a first and second mixing element of the static mixer according to FIG. 1;

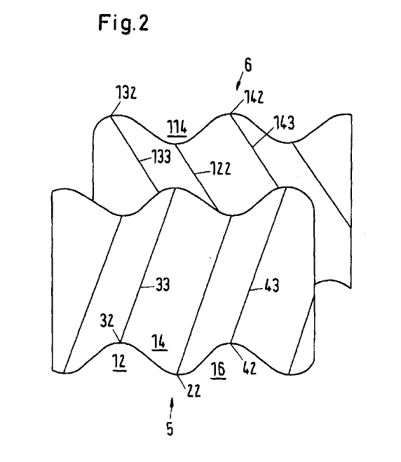

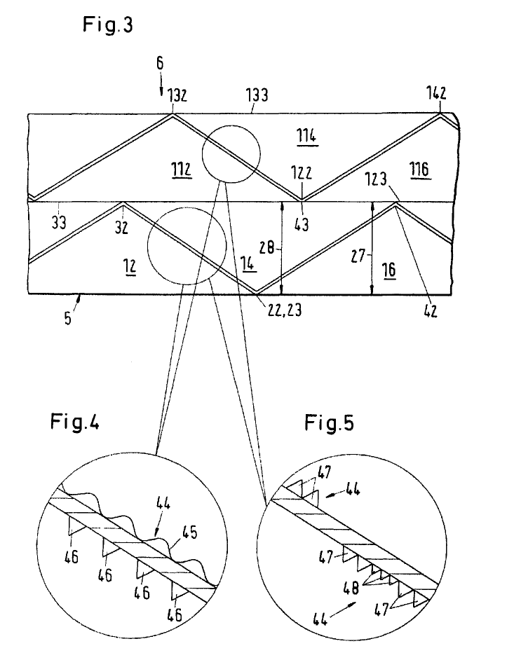

FIG. 3 a detail of a mixing element of the static mixer according to FIG. 1 or FIG. 2;

FIG. 4 a detail of the first sheet or second sheet showing two possible surface structures of small scale;

FIG. 5 a detail of the first or second sheet showing further possible surface structures;

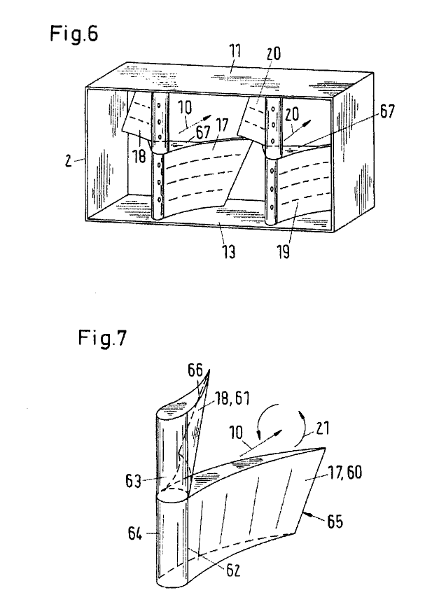

FIG. 6 a static mixer in accordance with a second embodiment;

FIG. 7 a mixing element of the static mixer of FIG. 6;

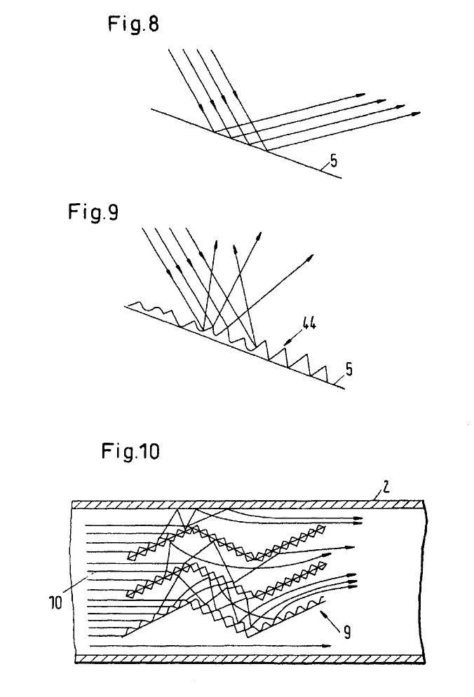

FIG. 8 the impact of dust particles of a conventional static mixer;

FIG. 9 the impact of dust particles on a static mixer according to the invention; and

FIG. 10 the flow of dust particles through the static mixer.

FIG. 1 shows a dust mixing device 1 in accordance with the invention including a closed passage 2 disposed on a longitudinal vertical axis; means (not shown) for directing a flow of flue gas containing dust particles into the closed passage 2 and along the longitudinal axis; and a static mixer 9 arranged in a passage 2.

The static mixer 9 is made of a plurality of mixing elements 3,4,5,6,7,8 which are in a regularly repeating geometrical relationship to one another. Each of the mixing elements 3,4,5,6,7,8 is made of thin-walled sheets which have a corrugated profile. The corrugated profile is characterized by a periodically repeating sequence of elevated portions, that is of corrugation peaks, and valley-like depressions, that is corrugation valleys. This corrugated profile can in particular be made as a fold with a zigzag section with acutely converging edges as shown in detail in FIG. 3.

FIG. 2 shows two adjacent mixing elements 5,6 of the static mixer 9 in accordance with FIG. 1. A first mixing element 5 is arranged adjacent to a second mixing element 6. The first mixing element 5 and the second mixing element 6 can in particular include a thin-walled sheet made of sheet metal, metal fabric, plastic or of ceramic material. The sheet can at least partially be provided with a coating of plastics, metals, metal alloys, metal oxides, ceramics, cermets or carbides or combinations thereof to enhance the resistance of the mixing element toward chemical influences such as corrosion or thermal influences such as temperature or mechanical influences such as pressure or erosion.

The corrugated profile can in particular comprise rounded peaks and valley bottoms as shown in FIG. 2.

The mixing elements 5, 6 are arranged with respect to one another so that the corrugated profiles of two adjacent mixing elements, thus two adjacent sheets are inclined at an angle to the main direction of flow 10. The corrugated profiles of adjacent sheets are arranged cross-wise with respect to one another.

The first mixing element 5 and the second mixing element 6 in FIG. 3 are shown in a view which shows a detail of the surface of the static mixer exposed to the dust flow, thus in a section normal to the main axis of the passage 2.

The first mixing element 5 has a corrugated profile with a plurality of open channels 12, 14, 16 being formed. The channels include a first corrugation valley 22, a first corrugation peak 32 and a second corrugation peak 42. The first corrugation peak 32 and the second corrugation peak 42 bound the first corrugation valley 22. The first corrugation peak 32 and the second corrugation peak 42 have a first apex 33 and a second apex 43.

The normal spacing between the first apex 33 of the first corrugation peak 32 and the valley bottom 23 of the first corrugation valley 22 is called the corrugation height 28.

In a mixing element in accordance with this embodiment, the valley height 28 is in particular substantially constant, that is the variations of the height are in the range of the usual tolerances which lie in the region of 0.1 mm-10 mm depending on the size of the element.

The second mixing element 6 of the static mixer has a corrugated profile with a plurality of open channels 112, 114, 115 being formed. The channels include a first corrugation valley 122, a first corrugation peak 132 and a second corrugation peak 142. The first corrugation peak 132 and the second corrugation peak 142 bound the first corrugation valley 122. The first corrugation peak 132 and the second corrugation peak 142 have a first apex 133 and a second apex 143.

The normal spacing 27 extends from the valley bottom 23 of the corrugation valley 22 to the corresponding valley bottom 123 of the second mixing element 6.

The normal spacing 27 can be the same or greater than the corrugation height 28. If the normal spacing 27 is the same as the corrugation height 28, the first and second mixing elements are in contact, whereas if the normal spacing 27 is greater than the corrugation height, a gap is formed between the first mixing element 5 and the second mixing element 6.

At least a part of the apex can be formed as an edge. At least some of the corrugation valleys can be formed in a V shape. The normal spacing between the valley bottom and the apex is essentially the same for all corrugation peaks of the mixing element in accordance with FIG. 3.

The first mixing element 5 can be arranged crosswise to the second mixing element 6. The angle of corrugation can be in a range of 10 to 90°, preferably in a range of 20 to 80°, most preferred in a range of 25 to 75°. The angle of corrugation is defined as the angle between the first apex 33 of the first mixing element 5 and the first apex 133 of the second mixing element 6.

FIG. 4 shows a detail of the corrugated profile providing a view of the small-scale surface structure 44 of one of the mixing elements. The surface structure 44 can comprise a continuous wave-like structure 45 or a structure containing individual peaks or protrusions 46 (contiguous or spaced apart) or ribs (contiguous or spaced apart) or grooves (contiguous or spaced apart).

FIG. 5 shows a further detail of the corrugated profile providing a view on the surface structure 44 of one of the mixing elements in which a surface structure is only provided on a portion of the surface of the mixing element. Alternatively or in addition thereto, a combination of different surface structures may be provided, for example surface structures of variable height may be provided, such as provided by individual peaks 47, 48 of different sizes and height and whether contiguous or spaced apart.

An additive can be introduced into a dust flow, thus a flow of dust particles alone or contained in a gas flow. The additive is to be mixed thoroughly with the dust flow. The additive can be supplied in its liquid state and be vaporised only when contacted by the dust flow. In such cases, spray nozzles may be employed to spray the additive directly into the dust flow. For a liquid additive spray nozzles are used to disperse the liquid into fine droplets in the dust flow.

As an example, spray nozzles are used frequently for dispersing of liquid water-ammonia mixture (NH₄OH) directly into the dust flow in flue gas denitrification plants such as those in thermal power plants.

The static mixer according to a second preferred embodiment as shown in FIG. 6 contains a plurality of mixing or guide elements 17, 18, 19, 20 which are formed in particular as thin-walled guide elements and extend in the flow direction in such a way that they offer the lowest possible flow resistance. The guide elements 17, 18, 19, 20 can be attached to the wall of the passage 2 at their outer edges, for example by a welded connection. The passage 2 is in this case of rectangular shape. Alternatively the passage 2 may be a pipe of circular cross-section. An upper side 11 and a lower side 13 of the passage 2 define the height of the passage 2. In the illustrated detail in FIG. 7, the guide elements 17, 18 are shown as wing-shaped vanes. The guide elements are at least partly provided with surface structures, such as for instance shown in FIG. 5 or FIG. 6.

The static mixer intensifies the turbulent flow present in passage 2 and generates additional large vortices which promote the large scale distribution of dust transverse to the main flow direction. Different constructions for such static mixers can be considered. Static mixers which have a low pressure drop are disposed with mixing elements which do not cause the flow to detach. An example for a static mixer with a favourable pressure drop is described in WO2008000616. The vortex-generating guide elements 17, 18 are arranged such that the flow does not detach.

The larger dust particles show a slip behaviour compared to the main flow when the flow lines are curved. Therefore, at least the larger dust particles can not follow the deflection of the flow in the passage caused by the guide elements. In the vortex behind the static mixer, the dust particles can also move away from the center of the vortex into the direction of the walls of the passage 2. Thus also the walls of the passage may be provided with surface structures, as for instance disclosed in FIG. 4 or FIG. 5.

The mixing element shown in FIG. 7 includes at least one pair of guide elements 17, 18 generating a flow swirl 21, whose axis faces in the direction of the flow 10, in the passage 2. The pair of guide elements 17, 18 includes a first vane 60 and a second vane 61. The edges 63, 64 of the vanes 60, 61 at the front end 62 of the mixing element at the leading side are rounded and perpendicular to the flow 10 and parallel to the height of the passage 2.

According to FIG. 7, the vanes 60 and 61 have onflow surfaces or side walls 65, 66 which follow the front end 62 downstream and which are bent out in a concave manner and in opposite senses. The axis of the passage 2 defines the direction of flow being the main flow in which the swirl 21 faces.

A horizontally disposed gusset 67 can be provided for an improved mechanical stability of the vane pair 60, 61. The gusset 67 connects the side walls of vane 60 to vane 61 as best shown in FIG. 6.

The vanes 60, 61 made as lightweight constructions can be made such that, with a vane height of one metre (or also more), they lack natural vibrations whose frequencies lie within the range from 1 to 10 Hz. The natural vibrations lying outside this range are not excited by the flow 10. Due to the aerodynamic shape of the vanes, during the inflow, the flow 10 enters into a region of the static mixer elements in which the flow cross-sections between the vanes reduces continuously. Thereby, the kinetic energy of the flow is increased and a pressure drop is observed. The flow cross-sections subsequently expand in the manner of a diffuser. In the region of the diffusor, the pressure can increase again without any substantial dissipation of the kinetic energy. The reduced dissipation has the consequence that only weakly formed secondary vortices are created. The vanes 60, 61 are preferably stiffened by the lightweight constructions such that an excitement of oscillations is also either fully absent due to changed mechanical properties or is at least shifted towards higher and so non-critical oscillation frequencies.

Alternatively the profile of the guide element can be hollow and a metering element provided inside the guide element for introducing an additive into the flow.

FIG. 8 shows the impact of dust particles on a conventional static mixer. The dust particles, which arrive in roughly parallel tracks are reflected on the surface of the static mixing element and leave also in roughly parallel tracks. When subjected to the flow, the dust particles are entrained by the flow and their tracks tend to merge, thus the concentration of dust particles can locally increase.

In FIG. 9, wherein like reference characters indicate like parts as above, the mixing element is provided with a surface structure 44 of a small scale. Such a structure of a small scale can comprise a plurality of ribs, grooves, protrusions, as described above. The surface structure of a small scale has an effect on the angle of reflexion of the dust particles. Due to the fact that a surface structure of a small scale is characterised by a locally variable angle of the surface with respect to the flow, neighbouring dust particles may impact at different angles on the surface of the mixing element. Therefore, the dust particles are reflected from the surface in a random fashion. Consequently the formation of concentrations of dust particles in certain regions of the surface due to the formation of streams of a high dust particle concentration or of a concentration of large dust particles can be avoided at least to some extent.

The surface structure of a small scale can be applied advantageously for mixing elements which are already known to be advantageous e.g. in static mixers as disclosed in U.S. Pat. No. 3,785,620 or WO2008/000616.

FIG. 10 shows the flow of dust particles through the static mixer which is provided with mixing elements 9 as described with respect to FIG. 1 in the passage 2. The mixing elements are disposed with a structure of a small scale. Schematically, the progression of dust particles through the static mixer is shown. The dust particles are reflected as shown in FIG. 9 and thereby are distributed randomly into the flow passing the mixing elements. Thereby the formation of streams of a high concentration of dust particles can be avoided. Thereby the life time of the static mixer and any apparatus arranged downstream of the static mixer can be increased.

Certainly, different types of static mixers from the ones described above can be considered, provided each of the static mixers is disposed with at least one mixing element having a surface structure of a small scale.

In addition, the interior surfaces of the walls of the passage 2 may be provided with the surface structures 44 of small scale as described above to further reflect dust particles impinging thereon into the flow 10 in a random manner.

The means for directing a flue gas into the closed passage 2 may be of any type, such as a diesel engine as described in US-2008/0193353 or power station as described in U.S. Pat. No. 7,090,810.

1. A method of mixing dust comprising the steps of
positioning a static mixer in a closed passage wherein the static mixer has at least one mixing element having a surface inclined relative to a main axis of said passage and a surface structure of small scale disposed on said surface;
introducing a flow of gas containing dust particles into the closed passage; and
directing the flow of gas containing dust particles in the closed passage through said static mixer whereby dust particles arriving at said surface of said mixing element are reflected from said surface structure in a random manner and are distributed homogenously within the flow of gas.

2. A method as set forth in claim 1 wherein said mixing element has a first wall thickness and said surface structure has a second wall thickness, said second wall thickness being at most twice said first wall thickness.

3. A method as set forth in claim 1 wherein said surface structure comprises at least one of projections, protrusions, ribs and grooves of a size of d50.

4. (canceled)

5. A method as set forth in claim 1 wherein said surface structure comprises a wave-like structure.

6. A method as set forth in claim 1 wherein said mixing element is corrugated profile having a periodically repeating sequence of elevated portions and valley-like depressions.

7. A method as set forth in claim 1 wherein said mixing element is a wave-shaped profile.

8. A method as set forth in claim 1 wherein said static mixer has a pair of said mixing elements and wherein each of said mixing elements has a corrugated profile forming a crosswise arrangement with the other of said pair of mixing elements for deflecting the flow of dust particles passing therethrough.

9. A method as set forth in claim 8 wherein each of said mixing elements has a plurality of open channels, each of said plurality of open channels including a first corrugation valley, a first corrugation peak and a second corrugation peak and wherein said first corrugation peak and said second corrugation peak bound said first corrugation valley.

10. A method as set forth in claim 9 wherein said first corrugation peak and said second corrugation peak have a first apex and a second apex and said corrugation valley has a valley bottom.

11. A method as set forth in claim 10 wherein said pair of said mixing elements are in touching contact a common point of contact between the apices thereof.

12. A method as set forth in claim 9 wherein said open channels of neighbouring mixing elements form an angle in a range of 10° to 90°.

13. A method as set forth in claim 1 wherein said mixing element is corrugated profile having a predetermined corrugation height and said surface structure has a height smaller than 1/20th of said predetermined corrugation height.

14. A method as set forth in claim 1 wherein said mixing element includes at least one pair of guide elements, each said guide element has a shape of a wing-shaped vane.

15. A method as set forth in claim 1 wherein said passage has a plurality of walls, each said wall having a surface structure of small scale disposed thereon for reflecting dust particles impinging thereon in a random manner.

16. A method of mixing dust comprising the steps of
positioning a static mixer in a closed passage wherein the static mixer has at least one mixing element having a surface inclined relative to a main axis of said passage and a surface structure of small scale disposed on said surface;
introducing a flow of gas containing dust particles into the closed passage; and
directing the flow of gas containing dust particles in the closed passage through said static mixer whereby dust particles arriving at said surface of said mixing element are distributed homogenously within the flow of gas.

17. A method as set forth in claim 16 further comprising the step of introducing a liquid additive into said flow of gas containing dust particles.

18. A method as set forth in claim 17 wherein said liquid additive is a liquid water-ammonia mixture.

19. A method as set forth in claim 16 wherein said mixing element includes at least one pair of guide elements, each said guide element being hollow and having a shape of a wing-shaped vane.

20. A method as set forth in claim 19 wherein each said guide element has a natural vibration frequency higher than 10 Hz.

21. A method as set forth in claim 19 further comprising the step of introducing a liquid additive into said flow of gas containing dust particles.
